(19) United States
(12) Patent Application Publication
(10) Pub. No.: US 2016/0208726 A1
(43) Pub. Date: Jul. 21, 2016

(54) Fuel Filter Clogging Detection Device in Fuel Supply Circuit, and Working Machine

(71) Applicant: CATERPILLAR SARL, Geneva (CH)

(72) Inventors: Jun Tanaka, Tokyo (JP); Atsushi Tenjin, Tokyo (JP)

(73) Assignee: Caterpillar SARL, Geneva (CH)

(21) Appl. No.: 14/913,847

(22) PCT Filed: Sep. 2, 2014
(86) PCT No.: PCT/EP2014/068633

§ 371 Date: Feb. 23, 2016

(30) Foreign Application Priority Data
Sep. 4, 2013 (JP) 2013-183211

(51) Int. Cl. F02D 41/22; B01D 35/00; B01D 35/143; F02M 37/22; E02F 9/08

(52) U.S. Cl. CPC F02D 41/22; F02M 37/22; E02F 9/0866; B01D 35/1435; B01D 35/005; F02D 2041/224; F02D 2041/228

(57) ABSTRACT

A fuel filter clogging detection device detects clogging of a fuel filter in a fuel supply circuit and issues a warning. The device includes an atmospheric pressure sensor detecting atmospheric pressure, a filter outlet pressure sensor detecting outlet side pressure of the fuel filter, and a control unit calculating differential pressure between the atmospheric pressure and the outlet side pressure and obtaining a degree of clogging of the fuel filter from the differential pressure so as to output an alarm signal when the degree of clogging exceeds a threshold.

### TECHNICAL FIELD

The present invention relates to a fuel filter clogging detection device that detects a clogging of a fuel filter and gives an alarm in a fuel supply circuit that pressure-supplies a fuel, having been taken into a fuel pump from a fuel tank via the fuel filter, to an engine, and also relates to a working machine.

### BACKGROUND ART

When a low-quality fuel is used in a working machine, for example, a fuel filter is easily clogged. When management of the fuel filter is not sufficient, it is difficult to figure out when to replace the filter.

Conventionally, there has been a technique of detecting a differential pressure between a pressure on an entrance side of a fuel filter and a pressure on an exit side of the fuel filter, and calculating a fuel flow rate in a fuel pump after the fuel passes through the fuel filter, whereby a clogging degree of the fuel filter is calculated based on the difference of pressures on either side of the filter and the flow rate in the fuel pump (see Patent Document 1, for example).

Patent Document 1: Japanese Patent Application Laid-open No. 2009-257103

However, because working machines are used in various sites ranging from places below sea level to places above sea level, a fuel filter that filters a fuel supplied from a fuel tank is susceptible to influences of the atmospheric pressure that is different depending on altitude of working sites. Even when a level of clogging at a certain state seems identical to that at another state, the clogging level cannot be accurately determined, because of, for example, change in pressure which differs on either side of the filter.

Further, the working machines are used in large ranges of fields such as cold areas or cold periods and warm areas or warm periods. Depending on these areas or periods, a temperature of the fuel before a start of the engine changes, and the temperature of the fuel arises after the engine is started. Therefore, a viscosity of the fuel also changes depending on these temperature changes. When the viscosity has changed, even when a level of clogging at a certain state seems identical to that at another state, the clogging level cannot be accurately determined, because of, for example, change in pressure which differs on either side of the filter.

### DISCLOSURE OF THE INVENTION

The present invention has been made in view of the above, and an object of the invention is to provide a fuel filter clogging detection device in a fuel supply circuit, capable of accurately deciding a clogging state of a fuel filter even when altitude and the like change, and a working machine.

The invention described in claim 1 is a fuel filter clogging detection device in a fuel supply circuit. The fuel supply circuit includes: a fuel tank that stores a fuel; a fuel filter that filters the fuel supplied from within the fuel tank; and a fuel pump that pressure-supplies to an engine the fuel passed through the fuel filter. The fuel filter clogging detection device includes: an atmospheric pressure sensor that detects an atmospheric pressure; a filter exit pressure sensor that is provided on an exit side of the fuel filter and detects a pressure on the exit side of the fuel filter; and a control unit that has a function of calculating a differential pressure between the atmospheric pressure detected by the atmospheric pressure sensor and the pressure on the exit side of the fuel filter detected by the filter exit pressure sensor, and obtaining a clogging degree of the fuel filter from the differential pressure, and then outputting an alarm signal when the clogging degree exceeds a threshold value.

The invention described in claim 2 is the fuel filter clogging detection device in the fuel supply circuit described in claim 1 further including a fuel temperature sensor that detects a temperature of the fuel. The control unit includes a function of correcting the clogging degree of the fuel filter, based on the fuel temperature detected by the fuel temperature sensor.

The invention described in claim 3 is a working machine that includes: a machine body on which an engine is mounted; a working device which is mounted on the machine body; and the fuel filter clogging detection device described in claim 1 or 2 provided in a fuel supply circuit supplying a fuel to the engine.

According to the invention described in claim 1, the control unit includes the function of calculating a differential pressure between the atmospheric pressure detected by the atmospheric pressure sensor and the pressure at the exit side of the fuel filter detected by the filter exit pressure sensor, obtaining a clogging degree of the fuel filter from the differential pressure, and outputting an alarm signal when the clogging degree exceeds a threshold value. Therefore, even when the altitude changes, a clogging state of the fuel filter can be accurately decided, and a proper timing of exchanging the filter can be accurately understood.

According to the invention described in claim 2, the control unit includes the function of correcting the stuffing degree of the fuel filter, based on the temperature detected by the fuel temperature sensor, in addition to the function in claim 1. Therefore, even when the altitude and the temperature of the fuel change, a clogging state of the fuel filter can be accurately decided, and a proper timing of exchanging the filter can be accurately understood.

According to the invention described in claim 3, even when at least the altitude of a position of the working machine changes, a clogging state of the fuel filter can be accurately decided. Therefore, in large ranges of fields at places below sea level to places above sea level, the filter can be replaced at a proper timing.

### BRIEF DESCRIPTION OF THE DRAWINGS

FIG. 1 is a circuit diagram showing a fuel filter clogging detection device in a fuel supply circuit according to an embodiment of the present invention;

FIG. 2 is a characteristic diagram showing a relationship between a differential pressure and a clogging degree stored in a control unit of the detection device;

FIG. 3 is a flowchart showing a control procedure that is programed in the control unit of the detection device;

FIG. 4 is a side view of a working machine on which the detection device is mounted.

### BEST MODE FOR CARRYING OUT THE INVENTION

Hereinafter, the present invention will be described in detail based on one embodiment shown in FIG. 1 to FIG. 4.

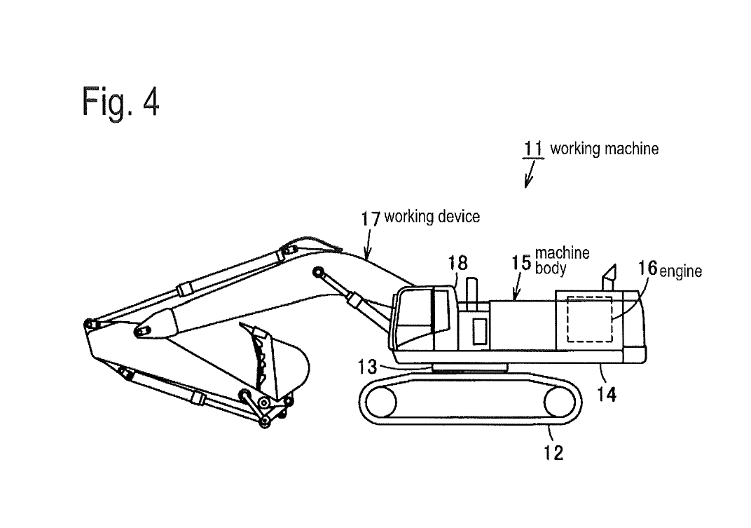

As shown in FIG. 4, a hydraulic shovel 11 as a working machine has an upper slewing body 14 which is slewably provided on a lower traveling body 12 via a slewing unit 13. The lower traveling body 12, the slewing unit 13, and the upper slewing body 14 form a machine body 15. On a rear part of the upper slewing body 14, there are mounted an engine 16, a hydraulic pump which is driven by the engine 16, and a fuel pump (these pumps are not shown in FIG. 1). On a front part of the upper slewing body 14, a working device 17 and a cap 18 are mounted.

FIG. 1 shows a fuel supply circuit 21 that supplies a fuel to the engine 16. The fuel supply circuit 21 includes a fuel tank 22 that stores a fuel F in a state of being communicated with the atmosphere, a fuel filter 23 that filters the fuel F supplied from within the fuel tank 22, and a fuel pump 24 that pressure-supplies the fuel F passing through the fuel filter 23 to the engine 16.

The fuel pump 24 has a low pressure pump, a high pressure pump, a main fuel-filter which is provided between the pumps, and the like. Further, the fuel F discharged from the fuel pump 24 (the high pressure pump) is distributed to a plurality of fuel injectors 26 via a common rail 25, and is injected to each combustion chamber within the engine 16 at each timing from each fuel injector 26.

A surplus fuel ejected from the fuel pump 24, the common rail 25, and each fuel injector 26, is returned to the fuel tank 22 through a return path 27.

In the fuel supply circuit 21 like this, there is provided a fuel filter clogging detection device 31 that detects a clogging of the fuel filter 23 and gives an alarm.

The fuel filter clogging detection device 31 includes an atmospheric pressure sensor 32 that detects an atmospheric pressure P1 such as an engine core sensor which is set in an intake manifold, for example, a filter exit pressure sensor 33 that is provided at an exit side of the fuel filter 23 and that detects an exit side pressure P2 of the fuel filter 23, and a control unit 35 such as an electronic control module (ECM) that includes a function of calculating a differential pressure ΔP between the atmospheric pressure P1 detected by the atmospheric pressure sensor 32 and the exit side pressure P2 of the fuel filter 23 detected by the filter exit pressure sensor 33, obtaining a clogging degree of the fuel filter 23 from the differential pressure ΔP, and outputting an alarm signal to an alarm unit 34 such as an alarm buzzer, an alarm lamp, and a monitor, when the clogging degree exceeds a threshold value.

The control unit 35 has an original function of controlling a fuel injection timing, an injection quantity, and the like of the fuel injector 26, based on a target engine rotation number and the like that are set by an accelerator dial (not shown), while detecting an engine rotation speed by an engine rotation number sensor 36. The control unit 35 also includes a function of adjusting a fuel pump flow rate by controlling the fuel pump 24.

At the exit side of the fuel filter 23, a fuel temperature sensor 37 that detects a temperature t of the fuel F is provided. The fuel temperature sensor 37 is connected to the control unit 35. The control unit 35 has a function of correcting the clogging degree of the fuel filter 23 based on the temperature t of the fuel F detected by the fuel temperature sensor 37, and has a function of correcting a temperature dependency that a viscosity of the fuel F decreases due to a rise in the temperature t, in addition to the above function.

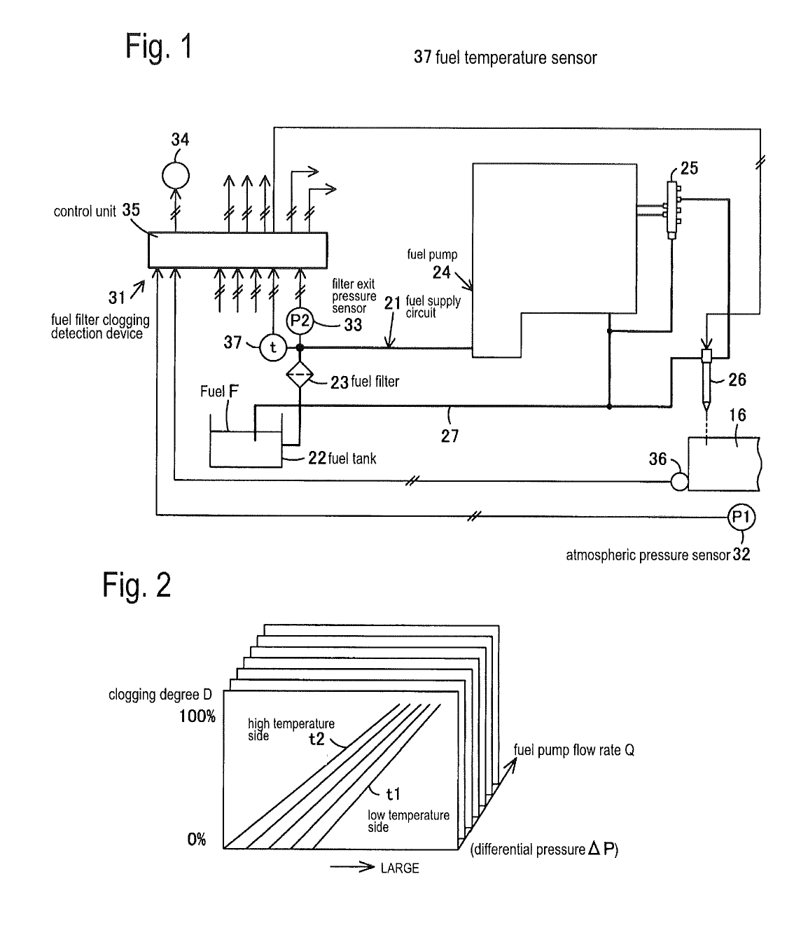

That is, as shown in a characteristic diagram in FIG. 2, a memory of the control unit 35 stores, by mapping or by a numerical expression, a relationship between the differential pressure AP between the atmospheric pressure P1 and the exit side pressure P2 of the fuel filter 23 and a clogging degree D of the fuel filter 23, at a specific fuel pump flow rate, for each temperature t of the fuel F.

In FIG. 2, even when the differential pressure ΔP is the same, when the temperature t of the fuel F is a high temperature (t2) higher than a low temperature (t1), for example, a viscosity of the fuel F decreases by a temperature rise equivalent. By a degree of easiness of the fuel F passing through the fuel filter 23, the fuel clogging state is more progressed. Therefore, it is decided that the clogging degree D of the fuel filter 23 is higher.

FIG. 2 shows a characteristic of the differential pressure ΔP versus the clogging degree D in a specific target engine rotation number (an accelerator dial value), that is, a specific fuel pump flow rate, in a no-load state after a specific time passes since the engine is started. By forecasting and storing in advance the characteristic of the differential pressure ΔP versus the clogging degree D shown in FIG. 2, for each different fuel pump flow rate, in the memory of the control unit 35, the clogging degree D can be obtained from the differential pressure ΔP and the temperature t, at an arbitrary fuel pump flow rate. In short, because the control unit 35 always understands the fuel pump flow rate from a signal for controlling the fuel pump 24, the control unit 35 can also correct the threshold value based on the fuel pump flow rate.

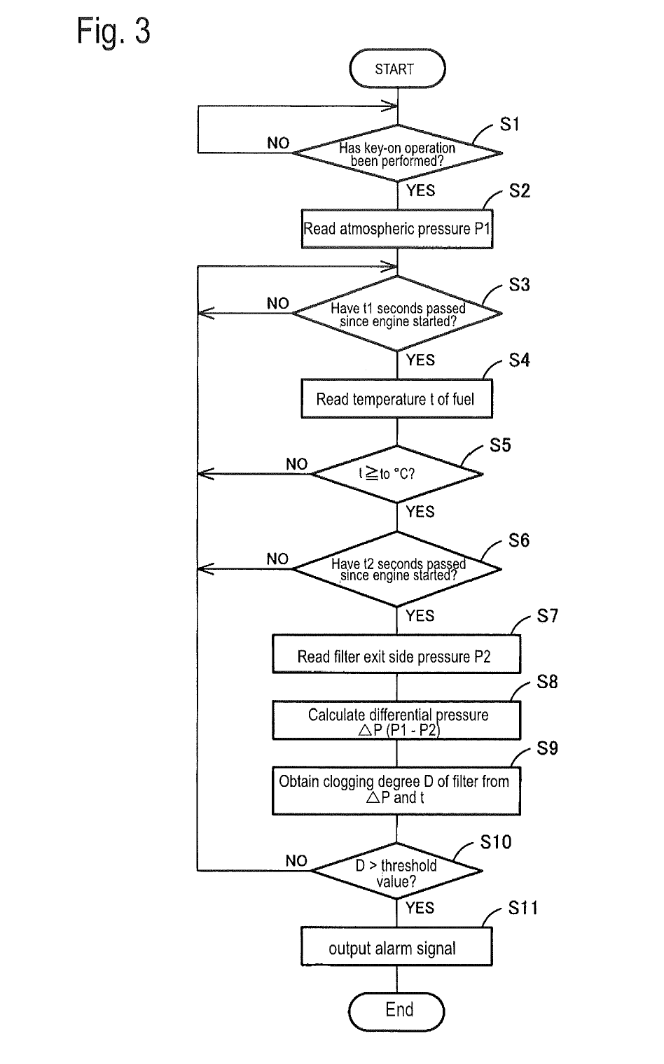

Next, based on a flowchart shown in FIG. 3, a control procedure which is programed in the control unit 35 will be described. It is assumed that, in order to check the filter clogging degree by using a constant fuel pump flow rate, this program is executed in a specific target engine rotation number (an accelerator dial value) in a no-load state.

(Step S1)

It is decided whether an engine key has been operated at an on position.

(Step S2)

By a key-on operation, the atmospheric pressure P1 detected by the atmospheric pressure sensor 32 is read.

(Step S3)

It is decided whether T1 seconds (a few seconds to a few dozens of seconds) have passed since the engine 16 was started, after the engine key was operated from an on position to a start position.

(Step S4)

After the T1 seconds have passed since the engine was started, the fuel temperature sensor 37 provided at the exit side of the fuel filter 23 can detect the temperature t of the fuel F within the fuel tank 22. Therefore, the temperature t of the fuel F is read.

(Step S5)

It is decided whether the temperature t of the fuel F is equal to or higher than reference temperature to ° C.

(Step S6)

It is decided whether T2 seconds (a few hundred seconds) have passed since the engine 16 was started.

(Step S7)

After the decisions in steps S5 and S6 are cleared, a state that the exit side pressure P2 of the fuel filter 23 becomes stable is awaited, and the exit side pressure P2 of the fuel filter 23 is read.

(Step S8)

The differential pressure ΔP (=P1−P2) between the atmospheric pressure P1 and the exit side pressure P2 of the fuel filter 23 is calculated.

(Step S9)

Based on the differential pressure ΔP and the temperature t of the fuel F, the clogging degree D of the fuel filter 23 is obtained, from the relationship of FIG. 2 which is stored in the memory of the control unit 35.

(Step S10)

It is decided whether the clogging degree D is larger than the threshold value which is set in advance.

(Step S11)

When the clogging degree D is larger than the threshold value, the alarm signal is output to operate the alarm unit 34 such as the alarm buzzer, the alarm lamp, and the monitor, thereby notifying the operator and the like that it is the time for replacing the fuel filter 23.

Next, work effects of the illustrated embodiment will be described.

The hydraulic shovel 11 shown in FIG. 4 has a possibility of being used in large ranges of fields at places at zero meter above sea level to places at 5,500 meters above sea level.

The atmospheric pressure changes by as much as 50 kPa at zero meter above sea level and at 5,500 meters above sea level. A method of obtaining the clogging degree D from the differential pressure ΔP between the atmospheric pressure P1 and the exit side pressure P2 of the fuel filter 23 utilizes a characteristic which is prepared in advance by using the atmospheric pressure P1 as a parameter. Therefore, the method can respond to influences of a change in altitude (a pressure difference 50 kPa).

The control unit 35 includes the function of calculating the differential pressure ΔP between the atmospheric pressure P1 detected by the atmospheric pressure sensor 32 and the exit side pressure P2 of the fuel filter 23 detected by the filter exit pressure sensor 33, obtaining the clogging degree D of the fuel filter 23 from the differential pressure ΔP, and outputting the alarm signal to the alarm unit 34, when the clogging degree D exceeds the threshold value. Therefore, even when the altitude changes, a clogging state of the fuel filter 23 can be accurately decided, and a proper timing of exchanging the filter can be accurately understood. In short, a proper timing of replacing the filter can be accurately understood while compensating for the change in the atmospheric pressure P1.

By forecasting and storing in advance the characteristic of the differential pressure ΔP versus the clogging degree D shown in FIG. 2, for each different fuel pump flow rate Q in the memory of the control unit 35, even when the fuel pump flow rate Q has changed, the control unit 35 that always understands the fuel pump flow rate Q from the signal for controlling the fuel pump 24 can obtain the clogging degree D from the differential pressure ΔP and the temperature t at the changed flow rate. In short, a proper timing of replacing the filter can be accurately understood while compensating for the change in the fuel pump flow rate Q.

Further, the control unit 35 that includes the mapped memory as shown in FIG. 2 by considering a differential pressure change due to the viscosity of the fuel F at each temperature, includes the function of correcting the clogging degree of the fuel filter 23 based on the temperature t of the fuel F detected by the fuel temperature sensor 37, in addition to the function of compensating for the change in the atmospheric pressure P1. Therefore, even when the temperature t of the fuel F changes, the clogging state of the fuel filter 23 can be accurately decided, without receiving influences of the temperature change. In short, a proper timing of replacing the filter can be accurately understood while compensating for the change in the temperature of the fuel F.

In this way, even when altitude of the position of the working machine and the fuel temperature change, the clogging state of the fuel filter 23 can be accurately decided. Therefore, in large ranges of fields at places below sea level to places above sea level, or in large ranges of fields such as cold areas or cold periods and warm areas or warm periods, the filter can be replaced at an optimum timing.

### INDUSTRIAL APPLICABILITY

The present invention has industrial applicability to business operators who are manufacturing or marketing a fuel filter clogging detection device in a fuel supply circuit, or a working machine that includes the clogging detection device.

### EXPLANATION OF REFERENCE NUMERALS

11 HYDRAULIC SHOVEL AS WORKING MACHINE
15 MACHINE BODY
16 ENGINE
17 WORKING DEVICE
21 FUEL SUPPLY CIRCUIT
22 FUEL TANK
23 FUEL FILTER
24 FUEL PUMP
31 FUEL FILTER CLOGGING DETECTION DEVICE
32 ATMOSPHERIC PRESSURE SENSOR
33 FILTER EXIT PRESSURE SENSOR
35 CONTROL UNIT
37 FUEL TEMPERATURE SENSOR
F FUEL
P1 ATMOSPHERIC PRESSURE
P2 EXIT SIDE PRESSURE OF FUEL FILTER
ΔP DIFFERENTIAL PRESSURE
D CLOGGING DEGREE
t FUEL TEMPERATURE

1. A fuel filter clogging detection device in a fuel supply circuit including:
a fuel tank that stores a fuel;
a fuel filter that filters the fuel supplied from within the fuel tank; and
a fuel pump that pressure-supplies the fuel passed through the fuel filter to an engine,
the fuel filter clogging detection device comprising:
an atmospheric pressure sensor that detects an atmospheric pressure;
a filter exit pressure sensor that is provided on an exit side of the fuel filter and detects a pressure on the exit side of the fuel filter; and
a control unit that has a function of calculating a differential pressure between the atmospheric pressure detected by the atmospheric pressure sensor and the pressure on the exit side of the fuel filter detected by the filter exit pressure sensor, and obtaining a clogging degree of the fuel filter from the differential pressure, and then outputting an alarm signal when the clogging degree exceeds a threshold value.

2. The fuel filter clogging detection device in the fuel supply circuit according to claim 1, further comprising a fuel temperature sensor that detects a temperature of the fuel, wherein the control unit comprises a function of correcting the clogging degree of the fuel filter, based on the fuel temperature detected by the fuel temperature sensor.

3. A working machine comprising:
a machine body on which an engine is mounted;
a working device which is mounted on the machine body; and
the fuel filter clogging detection device according to claim 1 provided in a fuel supply circuit supplying a fuel to the engine.

4. A working machine comprising:
a machine body on which an engine is mounted;
a working device which is mounted on the machine body; and
the fuel filter clogging detection device according to claim 2 provided in a fuel supply circuit supplying a fuel to the engine.

5. A fuel supply circuit comprising:
a fuel tank that stores a fuel;
a fuel filter that filters the fuel supplied from within the fuel tank;
a fuel pump that pressure-supplies the fuel passed through the fuel filter to an engine; and
a fuel filter clogging detection device including
an atmospheric pressure sensor that detects an atmospheric pressure,
a filter exit pressure sensor that is provided on an exit side of the fuel filter and detects a pressure on the exit side of the fuel filter, and
a control unit that has a function of calculating a differential pressure between the atmospheric pressure detected by the atmospheric pressure sensor and the pressure on the exit side of the fuel filter detected by the filter exit pressure sensor, and obtaining a clogging degree of the fuel filter from the differential pressure, and then outputting an alarm signal when the clogging degree exceeds a threshold value.

6. The fuel supply circuit according to claim 5, further including a fuel temperature sensor that detects a temperature of the fuel, wherein the control unit includes a function of correcting the clogging degree of the fuel filter, based on the fuel temperature detected by the fuel temperature sensor.

7. A working machine comprising:
a machine body on which an engine is mounted;
a working device which is mounted on the machine body; and
the fuel supply circuit of claim 5 supplying a fuel to the engine.

8. A working machine comprising:
a machine body on which an engine is mounted;
a working device which is mounted on the machine body; and
the fuel supply circuit of claim 6 supplying a fuel to the engine.
